(19) United States
(12) Patent Application Publication
(10) Pub. No.: US 2022/0197064 A1
(43) Pub. Date: Jun. 23, 2022

(54) ULTRA-CLOSE-RANGE METALLIC HEATER THERMO-OPTIC PHASE SHIFTER

(71) Applicant: Huazhong University of Science and Technology, Wuhan (CN)

(72) Inventors: Janji Dong, Wuhan (CN); Yanxian Wei, Wuhan (CN); Hailong Zhou, Wuhan (CN); Xinliang Zhang, Wuhan (CN)

(21) Appl. No.: 17/396,350

(22) Filed: Aug. 6, 2021

(30) Foreign Application Priority Data
Dec. 21, 2020 (CN) 202011517297.0

(51) Int. Cl. G02F 1/00; G02F 1/01; G02F 1/025

(52) U.S. Cl. CPC G02F 1/009; G02F 1/025; G02F 1/0102; G02F 1/0147

(57) ABSTRACT

The present invention belongs to the field of integrated optical waveguide modulation, and specifically, relates to an ultra-close-range metallic heater thermo-optic phase shifter, which includes: a substrate, and a metallic heater and an optical waveguide respectively arranged on the substrate; in which the metallic heater and the optical waveguide are arranged at a close distance, and the distance is less than 600 nm. The material of the metallic heater is titanium, titanium nitride, aluminum, gold, and/or a metal with a larger imaginary part of the refractive index. The present invention includes two solutions: side heating and top surface heating. In the side heating solution, the heater is placed close to a side of the waveguide in parallel, and heat is conducted to the optical waveguide through the substrate to achieve thermo-optic phase shift; while in the top surface heating solution, an auxiliary waveguide is placed on a side of the optical waveguide, and the heater is placed above the auxiliary waveguide; heat is conducted to the optical waveguide through a top silicon oxide layer to achieve thermo-optic phase shift. The present invention utilizes the principle of parity-time symmetry, greatly shortens the distance between the heaters and the waveguide, realizes low-loss and high-rate thermo- optic modulation. In addition, it is compatible with the CMOS process, and is a standard process.

### TECHNICAL FIELD

The present invention belongs to the field of integrated optical waveguide modulation, and specifically, relates to an ultra-close-range metallic heater thermo-optic phase shifter.

### BACKGROUND ART

The information explosion has become a serious challenge faced by the current communication system. In order to handle the ever-increasing data, many solutions have been proposed. Among them, integrated silicon photonics is a very promising solution due to its advantages of high-rate, low-loss, and compactness. In order to build an on-chip communication system, a modulator is essential. There are many on-chip modulation solutions, such as electro-optic modulation, thermo-optic modulation, and electro-absorption modulation. Among them, thermo-optic modulation has the advantages of low loss, simple implementation, and low energy consumption, and has been widely used in various on-chip systems.

Thermo-optic modulation has been widely used in various fields, such as optical communications, optical phased arrays, optical neural networks, quantum communications, and so on. A thermo-optic phase shifter is a basic unit in these applications. By carefully designing the basic unit, the performance of the optical system can be greatly improved. In general, the thermo-optic phase shifters use metal or doped silicon materials as heaters. The traditional metallic heater thermo-optic phase shifter keeps the heating area away from the waveguide due to the absorption, and the thick air layer or silicon oxide layer between the metallic heater and the waveguide restricts the heat conduction and dissipation, thereby limiting the modulation rate. Although there are some studies to speed up heat conduction and dissipation through some technical methods, such as trenching and slow-light photonic crystals, the performance of the metallic heater thermo-optic phase shifter has not been greatly improved. A doped silicon heater will introduce a certain amount of loss due to the carrier absorption, which cannot be used in large-scale thermo-optic modulation networks. Other new types of thermo-optic phase shifters require special new materials or complex manufacturing processes, leading to restrictions on their commercial production. Considering the wide application of thermo-optic phase shifters, the development of a CMOS process compatible, high-rate, low-loss thermo-optic phase shifter has great practical values.

### SUMMARY OF THE INVENTION

The present invention provides an ultra-close-range metallic heater thermo-optic phase shifter, which can solve the technical problem of having difficulties to meet the increasing demand for information processing due to high energy loss and low modulation rate when the existing thermo-optic phase shifters are used to perform thermo-optic modulation on optical waveguides.

The present invention employs the following technical solution to solve the above technical problem: an ultra-close-range metallic heater thermo-optic phase shifter, including: a substrate, and a metallic heater and an optical waveguide respectively arranged on the substrate;

wherein the metallic heater and the optical waveguide are arranged at a close distance, the distance is less than 600 nm; and a material of the metallic heater is titanium, titanium nitride, aluminum, gold and/or a metal with a larger imaginary part of a refractive index thereof.

The present invention has the following beneficial effects: when the metallic heater material is titanium, titanium nitride, aluminum, gold, and/or a metal with a larger imaginary part of the refractive index thereof, the present invention arranges the metallic heater and the optical waveguide in the phase shifter at an ultra-close distance. This solution has its feasibility demonstration based on the principle of parity-time symmetry and has been verified by simulation. The metallic heater is placed close to the optical waveguide to shorten the heating distance without introducing large losses, and a thermo- optic phase shifter with low loss, high rate and compatible with commercial production processes is achieved. The traditional commercial thermo-optic phase shifter uses metal or doped silicon as the heater. However, the metallic heater can be affected by the light absorption effect, and the distance between the metallic heater and the waveguide is large, which limits the modulation rate; in addition, the doped silicon can introduce additional losses due to carrier absorption. Therefore, the present invention effectively solves the technical problem of having difficulties to meet the increasing demand for information processing due to high energy loss and low modulation rate when the existing thermo-optic phase shifters are used to perform thermo-optic modulation on optical waveguides.

On the basis of the above technical solution, the present invention further provides the following improvement.

Furthermore, the metallic heater and the optical waveguide are arranged in parallel and spaced apart on a surface of the substrate, the top covering layer of the metallic heater and the optical waveguide is air, thus the metallic heater serves as a lossy waveguide, heat from the metallic heater is conducted to the optical waveguide via the substrate to realize thermo-optic modulation of the optical waveguide.

The present invention further has the following beneficial effects: in this solution, the phase shifter is heated laterally from one side, and the metallic heater is located on one side of the optical waveguide to provide heat to the optical waveguide, thereby realizing a phase shifter with short distance, low loss and high modulation rate.

Furthermore, a horizontal distance between the metallic heater and the optical waveguide is from 200 nm to 600 nm.

The present invention further has the following beneficial effects: the horizontal distance is within an interval of 200 nm to 600 nm, which can ensure that the optical loss will not be too large, and at the same time ensure that the device has a relatively high modulation rate. If the distance is less than 200 nm, the light loss will be relatively large; if the distance is greater than 600 nm, it will affect the modulation rate.

Furthermore, the material of the substrate is silicon oxide. Furthermore, the phase shifter of the present invention further includes an auxiliary waveguides;

the auxiliary waveguide whose width is smaller than that of the optical waveguide is arranged on side of the optical waveguide in parallel and spaced apart, the metallic heaters is arranged above the auxiliary waveguide at an interval, an edge of a side of the metallic heater close to the optical waveguide does not exceed an edge of a side of the auxiliary waveguide close to the optical waveguide; a peripheral cover layer of the auxiliary waveguide and the optical waveguide is the silicon oxide, a top cover layer of the metallic heater is air, thus the metallic heater and the auxiliary waveguide as a whole serve as a lossy waveguide, and the heat of the metallic heater is conducted to the optical waveguide through the silicon oxide layer nearby to realize thermo-optic modulation of the optical waveguide.

The present invention further has the following beneficial effects: in this solution, the phase shifter is heated from the top thereof. The metallic heater is set on the upper left side of the optical waveguide. The metallic heater and the auxiliary waveguide are located on the same side of the optical waveguide and together constitute a lossy waveguide. The metallic heater provides heat to the optical waveguide from the top of the optical waveguide, thereby realizing a phase shifter of short distance, low loss and high modulation rate.

Furthermore, the height of the auxiliary waveguide is the same as the height of the optical waveguide.

Furthermore, the width of the auxiliary waveguide is greater than or equal to 200 nm and less than 500 nm, and the height of the auxiliary waveguide is 220 nm.

The present invention further has the following beneficial effects: the width of the auxiliary waveguide is obtained by simulation calculation. If its width is less than 200 nm, the fabrication requirements are relatively high and the auxiliary waveguide is easy to break. If its width is greater than 500 nm, higher-order modes may be excited, which may increase the optical loss.

Furthermore, the material of the substrate is silicon oxide, and a vertical distance between a bottom surface of the metallic heater and an upper surface of the auxiliary waveguide is from 100 nm to 500 nm.

The present invention further has the following beneficial effects: the thickness of silicon oxide should be as thin as possible, and the range of 100 nm to 500 nm is appropriate. If it is less than 100 nm, the fabrication process is not easy to control, and it is easy to damage the waveguide. If it is greater than 500 nm, this will affect the modulation rate.

Furthermore, a horizontal distance between the auxiliary waveguide and the optical waveguide is from 200 nm to 600 nm.

The present invention further has the following beneficial effects: the range of 200 nm to 600 nm ensures that the optical loss will not be too large, and at the same time a high modulation rate can be obtained. If the distance is less than 200 nm, the light loss will increase sharply. If the distance is greater than 600 nm, the modulation rate will decrease.

Furthermore, the height of the optical waveguide is 220 nm and the width thereof is from 400 nm to 700 nm.

### BRIEF DESCRIPTION OF THE DRAWINGS

FIG. 1 is a schematic structural diagram of a thermo-optic phase shifter provided by an embodiment of the present invention;

FIG. 2 is a theoretical simulation result of a thermo-optic phase shifter provided by an embodiment of the present invention;

FIG. 3 is an MZI diagram for testing a thermo-optic phase shifter provided by an embodiment of the present invention;

FIG. 4 is a transmission spectrum of the Mach-Zehnder interferometer MZI designed based on the thermo-optic phase shifter provided by an embodiment of the present invention;

FIG. 5 is an experimental characterization of response speed of a thermo-optic phase shifter provided by an embodiment of the present invention;

FIG. 6 is a schematic diagram of the influence of the gap size between the metallic heater and the optical waveguide on the performance parameters of the device provided by an embodiment of the present invention.

### DESCRIPTION OF THE EMBODIMENTS

To make the objects, technical solutions, and advantages of the present invention clear, the following further describes the present invention in detail with reference to the accompanying drawings and specific embodiments. It should be understood that the specific embodiments described herein are only used to explain the present invention, not limit the present invention. In addition, the technical features involved in the various embodiments of the present invention described below can be combined as long as they do not conflict with each other.

Embodiment one

An ultra-close-range metallic heater thermo-optic phase shifter includes: a substrate, and a metallic heater and an optical waveguide respectively arranged on the substrate;

wherein the metallic heater and the optical waveguide are arranged at a close distance, the distance is less than 600 nm; and a material of the metallic heater is titanium, titanium nitride, aluminum, gold and/or a metal with a larger imaginary part of a refractive index thereof.

The size of the metallic heater and the size of the optical waveguide can be the same or different.

The thermo-optic phase shifter can have a side heating solution 1 and a top surface heating solution 2. The side heating solution 1 is as follows: the metallic heater and the optical waveguide are arranged in parallel and spaced on the surface of the substrate. The top cover layer of the metallic heater and the optical waveguide is air, and the metallic heater serves as a lossy waveguide. The heat of the metallic heater is conducted to the optical waveguide through the substrate to realize thermo-optic modulation of the optical waveguide. The top surface heating solution 2 is as follows: the thermally modulated phase shifter further includes an auxiliary waveguide. The auxiliary waveguide is arranged on the side of the optical waveguide in parallel and spaced apart. The metallic heater is arranged above the auxiliary waveguide at an interval. The edge of a side of the metallic heater close to the optical waveguide does not exceed the edge of a side of the auxiliary waveguide close to the optical waveguide. The auxiliary waveguide and the outer cover layer of the optical waveguide is the silicon oxide. The top cover layer of the metallic heater is air, and the metallic heater and the auxiliary waveguide as a whole serve as a lossy waveguide. The heat of the metallic heater is conducted to the optical waveguide through the nearby substrate to realize the thermo-optic modulation of the optical waveguide.

The above solutions can achieve low-loss, high-rate thermo-optic modulation, is compatible with general commercial processes, and has the potential for large-scale applications. The theoretical verification thereof is provided as follows:

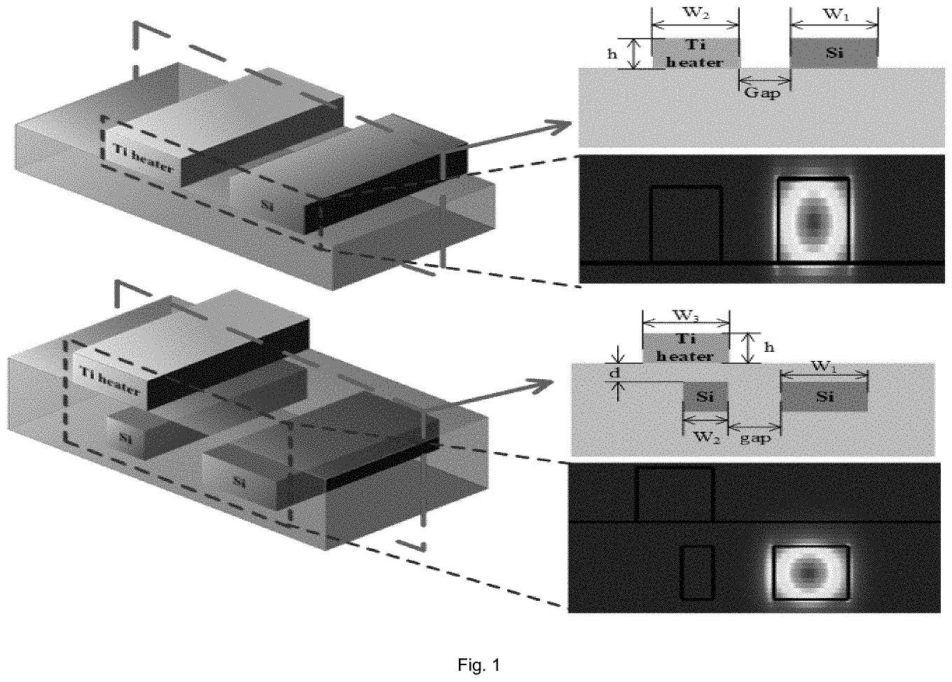

As shown in FIG. 1, the close range metallic heater thermo-optic phase shifter based on PT symmetry includes: a side heating solution 1, and a top surface heating solution 2. In the side heating solution (that is, the structure in the upper panel of FIG. 1), W₁ and W₂ are the widths of the optical waveguide and the thermal electrode, Gap is the gap distance between the metallic heater and the optical waveguide, h is the height of the optical waveguide and the metallic heater. In the top surface heating solution (that is, the structure in the lower panel in FIGS. 1), W₁, W₂, and W₃ are the widths of the optical waveguide, the auxiliary waveguide and the metallic heater, h is the height of the optical waveguide, the auxiliary waveguide and the metallic heater, d is the thickness of an oxide layer between the metallic heater and the auxiliary waveguide. The coupling system between the metallic heater and the optical waveguide can be described by the coupling

$$i \frac{d}{d z} ( \begin{matrix}{a}_{1} \\ {a}_{2}\end{matrix} ) = ( \begin{matrix}\frac{i {γ}_{1}}{2} & Ω \\ Ω & \frac{i {γ}_{2}}{2}\end{matrix} ) ( \begin{matrix}{a}_{1} \\ {a}_{2}\end{matrix} ) \qquad ( 1 )$$

wave equation:

a₁ and a₂ are the complex amplitudes of the optical field in the heater and the waveguide, Ωis the coupling coefficient, y₁,y₂ are the loss coefficient of the optical waveguide and the lossy waveguide. In the side heating system, the heater can be regarded as a lossy waveguide; in the top surface heating system, the heater and the auxiliary waveguide as a whole can be regarded as a lossy waveguide. After variable substitution

$${a}_{n} = {v}_{n} exp ( \frac{{γ}_{1} + {γ}_{2}}{4} z ) ,$$

the following can be obtained:

$$i \frac{d}{d z} ( \begin{matrix}{v}_{1} \\ {v}_{2}\end{matrix} ) = ( \begin{matrix}\frac{i γ}{2} & Ω \\ Ω & - \frac{i γ}{2}\end{matrix} ) ( \begin{matrix}{v}_{1} \\ {v}_{2}\end{matrix} ) \qquad ( 2 )$$

where

$$γ = \frac{{γ}_{1} - {γ}_{2}}{2}$$

is the loss difference between the two waveguides

The eigenvalue of equation (2) can be expressed as:

$$ɛ = \pm \sqrt{{Ω}^{2} - \frac{{γ}^{2}}{4}} .$$

It can be easily obtained that when

$$\vert Ω \vert > \vert \frac{γ}{2} \vert ,$$

the eigenvalue of the system is a real number, showing an

oscillating state, when

$$\vert Ω \vert < \vert \frac{γ}{2} \vert ,$$

the eigenvalue of the system is an imaginary number, showing a gain mode and a loss mode, that is, the PT symmetry broken state. From this, it can be obtained that in the PT symmetry broken state, the expression of the complex amplitude in the waveguide is as follows:

$${a}_{1} ( z ) = \{ ( \frac{1}{2} + \frac{γ}{4 \vert ɛ \vert i} ) {e}^{i \vert ɛ \vert z} + ( \frac{1}{2} - \frac{γ}{4 \vert ɛ \vert i} ) {e}^{- i \vert ɛ \vert z} \} exp ( \frac{{γ}_{1} + {γ}_{2}}{4} z ) \\ {a}_{2} ( z ) = ( - \frac{4 {\vert ɛ \vert}^{2} + {γ}^{2}}{8 \vert ɛ \vert Ω} {e}^{i \vert ɛ \vert z} - \frac{4 {\vert ɛ \vert}^{2} + {γ}^{2}}{8 \vert ɛ \vert Ω} {e}^{- i \vert ɛ \vert z} ) exp ( \frac{{γ}_{1} + {γ}_{2}}{4} z ) \qquad ( 3 )$$

Since the loss value of the metal waveguide is much larger than the loss value of the silicon waveguide and the coupling coefficient therebetween, the approximate condition

$$\vert Ω \vert = \vert \frac{γ}{2} \vert$$

can be brought into the equation (3), and it can be obtained

approximately as follows:

$$\vert Ω \vert = \vert \frac{γ}{2} \vert ,$$

that is, the light wave mainly propagates in the optical waveguide, not in the metal waveguide, and the loss is very low.

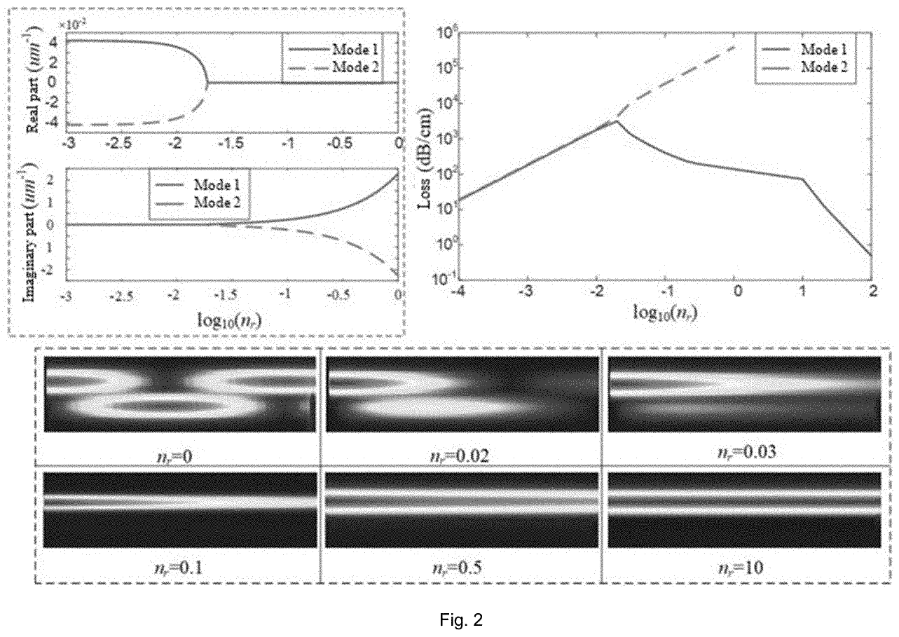

The above structure was further simulated and verified, and the result is shown in FIG. 2. The upper left panel in FIG. 2 shows the real and imaginary parts of the eigenvalue under different losses. It can be seen that when the loss reaches a certain value, the real part of the eigenvalue is degenerate, and the imaginary part is split. That is, the PT symmetry broken state is realized. The upper right panel in FIG. 2 shows the relationship between the loss of the two waveguide modes and the value of the lossy waveguide loss. When the loss of the lossy waveguide continues to increase, the loss of the mode in the optical waveguide first increases, then decreases, and finally approaches zero. This is the same as expected. The bottom panel in FIG. 2 shows the mode field distribution obtained by the finite time domain difference method. It can be seen that when the imaginary part of the refractive index of the lossy waveguide continues to increase, that is, when the loss continues to increase, the optical field will gradually be constrained in the low-loss waveguide, and when the loss is large enough, the optical field will propagate almost losslessly in the low-loss waveguide.

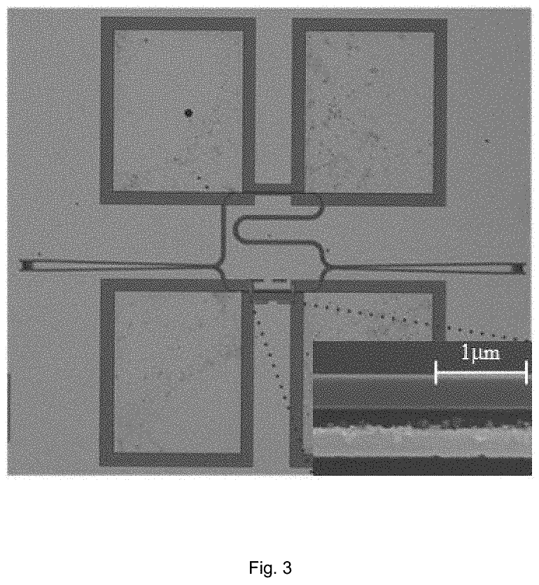

In order to verify the performance of the thermo-optic phase shifter, a Mach-Zehnder interference structure (MZI) is further designed and manufactured, and its transmission characteristics are then measured to characterize the performance of the thermo-optic phase shifter. The Mach-Zehnder interference structure is shown in FIG. 3. The broad-spectrum light is input into the structure through the vertically coupled grating, and is then divided into two paths by the Y branch for interference. The two path arm difference is about 400 um, and the length of the phase shifter is 100 um. Next, interference occurs after the Y-branch beams are combined, and then output by the vertically coupled grating and received by a spectrometer.

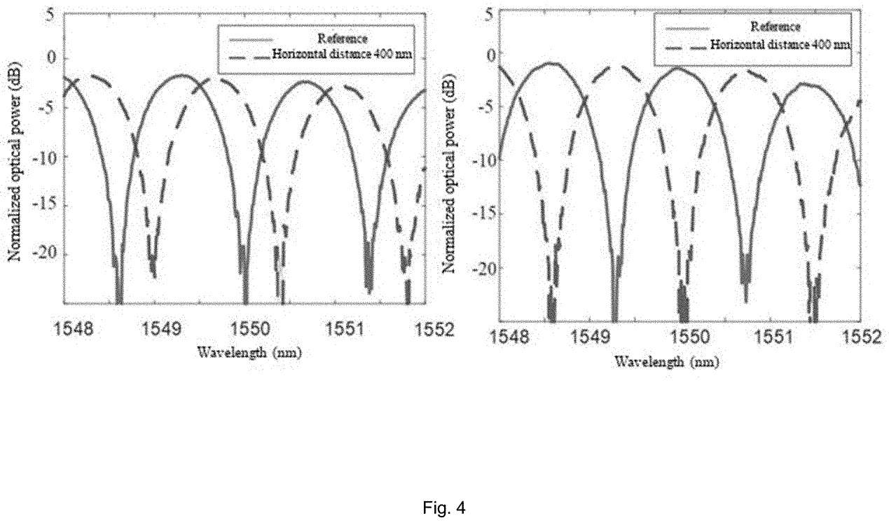

FIG. 4 shows the transmission spectrum of the side heating and top heating solutions. The left panel shows the transmission spectrum of MZI based on the side heating solution, while the right panel shows the transmission spectrum of MZI based on the top surface heating solution. By comparing the spectrum of the phase shifter and that of the reference MZI, the insertion loss introduced by the phase shifter can be obtained. The solid line in the figure is the reference MZI spectrum without the phase shifter, and the dashed line is the figure is the MZI spectrum with the phase shifter. With comparing the peak power difference between the two, it can be obtained that for a distance of 100 um, the loss introduced by the phase shifter corresponding to the side heating solution 1 is 0.1 dB. The loss introduced by the phase shifter corresponding to the top heating scheme 2 is 0.2 dB.

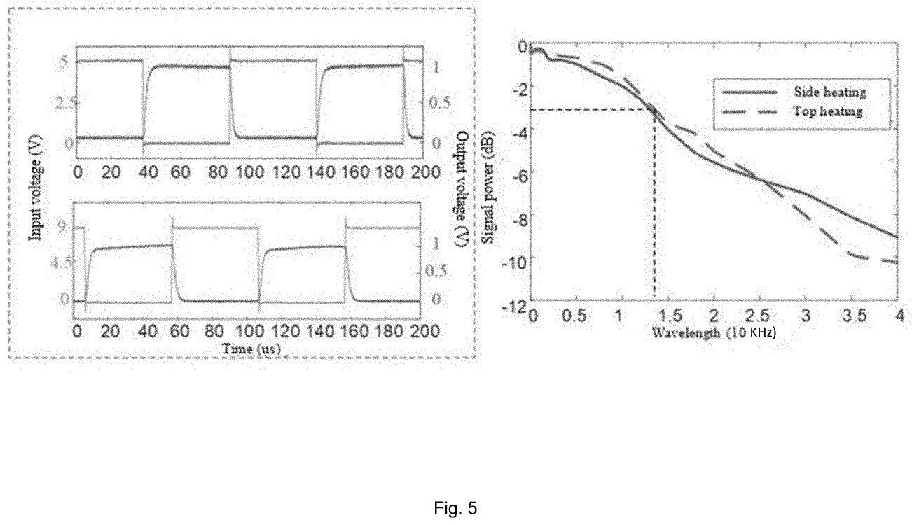

FIG. 5 shows the frequency response of the thermo-optic phase shifter. The upper left panel shows the response of the side heating solution with a 10 kHz square wave. The bottom left panel shows the response of the top surface heating solution a 10 kHz square wave. By calculating the rising and falling edges, the response bandwidth can be obtained. The panel on the right shows the response of the two solutions under different frequency sine waves, and the 3 dB bandwidth thereof can be directly obtained. The left panel shows the responses of the side heating solution and the top heating solution with a 10 kHz square wave. By measuring the rising and falling time period, the 3 dB bandwidth

can be estimated with the following formula

$$Δ f \approx \frac{0.35}{γ} ,$$

in which

$$γ = \frac{{γ}_{u p} + {γ}_{d o w n}}{2}$$

is the characteristic time of the device. In addition, the rising and falling time periods of the side heating solution are 1.35 us and 1.15 us respectively; the rising and falling time periods of the top surface heating solution are 2.05 us and 1.35 us, respectively. Using the formula, it can be estimated that the 3 dB bandwidth of the side heating solution is 280 kHz, and the 3 dB bandwidth of the top surface heating solution is 205 kHz. In order to accurately measure the bandwidth of the device, sine waves of different frequencies are input and the signal energy attenuation is then measured. The result is shown in the right panel of FIG. 5. It can be seen that the 3 dB bandwidth of the side heating solution is 275 kHz, and the bandwidth of the top heating solution is 200 kHz, which is consistent with the previous estimates. Compared with the modulation rate of about 10 kHz of a traditional metallic heater, the modulation rate of the phase shifter of the present invention has been significantly improved.

For the phase shifter corresponding to the side heating solution 1, preferably, the horizontal distance between the metallic heater and the optical waveguide is 200 nm to 600 nm.

First of all, the gap distance below 600 nm is super close with respect to the existing gap distance. In addition, if it is less than 200 nm, there may be a problem of light loss, that is, the metallic heater will affect the transmission of light in the optical waveguide. Moreover, considering the accuracy of the fabrication process, it is preferable that the horizontal gap distance is from 200 nm to 600 nm. Of course, under the condition that the metallic heater does not affect the light modulation of the optical waveguide, the smaller the gap, the better the result.

Preferably, the height of the optical waveguide is 220 nm and the width thereof is from 400 to 700 nm, and the material of the substrate is silicon oxide. For the phase shifter corresponding to the side heating solution 2, preferably, the height of the auxiliary waveguide is the same as the height of the optical waveguide.

Preferably, the width of the auxiliary waveguide is greater than or equal to 200 nm and less than 500 nm. The height of the auxiliary waveguide is 220 nm. The optical waveguide is 220 nm high and 500 nm wide. The material of the substrate is silicon oxide.

The vertical distance between the bottom surface of the metallic heater and the upper surface of the auxiliary waveguide is from 100 nm to 500 nm. The horizontal gap distance between the auxiliary waveguide and the optical waveguide is from 200 nm to 600 nm. In the production, the auxiliary waveguide and the optical waveguide can be formed by means of cutting a whole waveguide into an auxiliary waveguide and an optical waveguide. This preparation method is simple, on this basis, the height of the auxiliary waveguide is the same as that of the optical waveguide, and the vertical distance from the bottom surface of the metallic heater is the same.

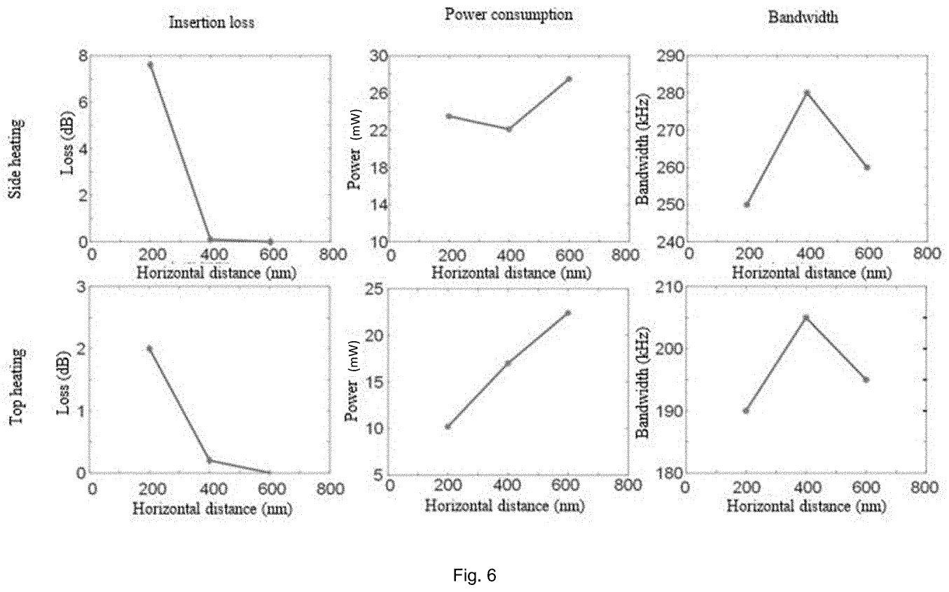

In order to verify the above values, the device performance parameters under different gaps are tested. As shown in FIG. 6, the top panel is the result of the side heating solution. The lower panel shows the result of the top surface heating solution. Due to the process of the verification experiment, the loss increased sharply when the gap distance is 200 nm (theoretically, the loss should be lower than that of the existing phase shifters), which is inconsistent with the simulation results. However, the 400 nm and 600 nm gap structures have achieved relatively successful results. As shown in FIG. 6, for the side heating solution, the insertion loss of the 400 nm gap is 0.1 dB, while the insertion loss of the 600 nm gap is negligible. The half-wave power consumption is 22.1 mW and 27.5 mW respectively. The rates are up to 280 kHz and 260 kHz respectively. For the top surface heating solution, the 400 nm gap insertion loss is 0.2 dB, and the 600 nm gap insertion loss is negligible, the half-wave power is 17.0 mW and 22.4 mW, and the rate is 205 kHz and 195 kHz, respectively.

Table 1 lists the loss and bandwidth of some metallic or doped silicon heaters. With comparison, it can be clearly seen that the designed solutions of the present invention have advantages in both loss and rate indicators. Moreover, the phase shifter of this embodiment is based on a standard process, does not require special operations, and has the potential for large-scale applications.

TABLE 1
Comparison of various thermal electrodes

| | | Loss | Bandwidth |
|---|---|---|---|
| Solution | | (dB) | (kHz) |
| Conventional | Optical cycle thermo-optic | 1.2 | 53.8 |
| electrode | phase shifter | | |
| | Optimized TiN thermo-optic | 0.4 | 62.5 |
| | phase shifter | | |
| | Doped silicon thermo-optic | 0.23 | 130 |
| | phase shifter | | |
| | Side heating PT symmetrical | 0.1 | 280 |
| | thermo-optic phase shifter | | |
| | Top heating PT symmetrical | 0.2 | 205 |
| | thermo-optic phase shifter | | |

In summary, the present invention provides a close-range metallic heater thermo- optic phase shifter based on PT symmetry. By virtue of the principle of PT symmetry breaking, a metal material with high refractive index imaginary part and low refractive index real part can be selected for the heaters. Under the condition of PT symmetry breaking, the heater can be placed near the waveguide at a close distance without introducing large losses. The imaginary part of the refractive index of the metal material characterizes the loss of the metal material; the real part is related to the coupling efficiency between the waveguide and the metal. A high imaginary part of the refractive index indicates that the loss is increased. The low real part of the refractive index indicates that the coupling coefficient is reduced. According to the PT symmetry breaking condition and the large loss approximation condition, light can be restricted to transmit in the optical waveguide without being affected by the metal waveguide. Hence, close distance heating can be achieved. Since the distance between the heater and the waveguide is greatly reduced compared with the traditional heaters, the heat conduction and dissipation rates have been significantly improved. It is specifically shown in its modulation rate. By designing the MZI structure, the 3 dB bandwidth of the side heating solution and the top heating solution are measured, which are 280 kHz and 205 kHz, respectively.

A person skilled in the art can easily understand that the above embodiments are only some preferred embodiments of the present invention and are not intended to limit the present invention. Any modification, equivalent replacement and improvement made within the principle of the present invention shall be included in the scope of protection of the present invention.

1. An ultra-close-range metallic heater thermo-optic phase shifter, characterized in that the phase shifter comprises: a substrate, and a metallic heater and an optical waveguide respectively arranged on the substrate;
wherein the metallic heater and the optical waveguide are arranged at a close distance, the distance is less than 600 nm; and a material of the metallic heater is titanium, titanium nitride, aluminum, gold and/or a metal with a larger imaginary part of a refractive index thereof.

2. The ultra-close-range metallic heater thermo-optic phase shifter according to claim 1, characterized in that the metallic heater and the optical waveguide are arranged in parallel and spaced apart on a surface of the substrate, a top covering layer of the metallic heater and the optical waveguide is air, thus the metallic heater serves as a lossy waveguide, heat from the metallic heater is conducted to the optical waveguide via the substrate to realize thermo-optical modulation of the optical waveguide.

3. The ultra-close-range metallic heater thermo-optic phase shifter according to claim 2, characterized in that a horizontal distance between the metallic heater and the optical waveguide is from 200 nm to 600 nm.

4. The ultra-close-range metallic heater thermo-optic phase shifter according to claim 2, characterized in that a material of the substrate is silicon oxide.

5. The ultra-close-range metallic heater thermo-optic phase shifter according to claim 1, characterized in that the phase shifter further comprises an auxiliary waveguide;
the auxiliary waveguide whose width is smaller than that of the optical waveguide is arranged on a side of the optical waveguide in parallel and spaced apart, the metallic heater is arranged above the auxiliary waveguide at an interval, an edge of a side of the metallic heater close to the optical waveguide does not exceed an edge of a side of the auxiliary waveguide close to the optical waveguide; a peripheral cover layer of the auxiliary waveguide and the optical waveguide is silicon oxide, a top cover layer of the metallic heater is air, thus the metallic heater and the auxiliary waveguide as a whole serve as a lossy waveguide, and the heat of the metallic heater is conducted to the optical waveguide through the substrate nearby to realize thermo-optic modulation of the optical waveguide.

6. The ultra-close-range metallic heater thermo-optic phase shifter according to claim 5, characterized in that a height of the auxiliary waveguide is the same as a height of the optical waveguide.

7. The ultra-close-range metallic heater thermo-optic phase shifter according to claim 5, characterized in that a width of the auxiliary waveguide is greater than or equal to 200 nm and less than 500 nm, and a height of the auxiliary waveguide is 220 nm.

8. The ultra-close-range metallic heater thermo-optic phase shifter according to claim 5, characterized in that a material of the substrate is silicon oxide, and a vertical distance between a bottom surface of the metallic heater and an upper surface of the auxiliary waveguide is from 100 nm to 500 nm.

9. The ultra-close-range metallic heater thermo-optic phase shifter according to claim 8, characterized in that a horizontal distance between the auxiliary waveguide and the optical waveguide is from 200 nm to 600 nm.

10. The ultra-close-range metallic heater thermo-optic phase shifter according to any one of claims 1 to 9, characterized in that a height of the optical waveguide is 220 nm and a width thereof is from 400 nm to 700 nm.
